(19) United States
(12) Patent Application Publication
(10) Pub. No.: US 2025/0297902 A1
(43) Pub. Date: Sep. 25, 2025

(54) LOAD SENSOR

(71) Applicant: Panasonic Intellectual Property Management Co., Ltd., Osaka (JP)

(72) Inventors: YUI AIHARA, Osaka (JP); SUSUMU URAGAMI, Kumamoto (JP); TAKASHI MATSUMOTO, Osaka (JP); YODAI MATSUMURA, Osaka (JP); SHINOBU MASUDA, Osaka (JP); TAKAFUMI HAMANO, Fukuoka (JP)

(21) Appl. No.: 19/228,826

(22) Filed: Jun. 5, 2025

Related U.S. Application Data
(63) Continuation of application No. PCT/JP2023/041324, filed on Nov. 16, 2023.

(30) Foreign Application Priority Data
Jan. 11, 2023 (JP) 2023-002742

(51) Int. Cl. G01L 1/14

(52) U.S. Cl. CPC G01L 1/142

(57) ABSTRACT

Provided is a load sensor capable of enhancing load detection sensitivity with a simple configuration. A load sensor includes a conductive elastic member (a base member and a conductive elastic body), a conductive member disposed on the conductive elastic member, and a dielectric material interposed between the conductive elastic member and the conductive member. The conductive elastic member has an uneven shape on a surface opposite to a surface on which the conductive member is overlapped.

### BACKGROUND

### 1. Technical Field

The present disclosure relates to a load sensor that detects a load based on a change in electrostatic capacitance.

### 2. Description of the Related Art

Conventionally, as a human machine interface (HMI), an electrostatic capacitance type load sensor is used for various devices such as a keyboard and a game controller.

For example, PTL 1 shown below describes a load sensor including a conductive member made of a wire material having conductivity, a conductive elastic body having elasticity, and a dielectric material covering a surface of the conductive member. The conductive member covered with the dielectric material is overlapped with a surface of the conductive elastic body. When the conductive member is pressed against the conductive elastic body by a load, the conductive elastic body deforms so as to wrap the conductive member. As a result, the contact area between the dielectric material and the conductive elastic body changes, and the electrostatic capacitance between the conductive member and the conductive elastic body changes. By measuring the electrostatic capacitance, the load applied to the load sensor is detected.

### CITATION LIST

### Patent Literature

PTL 1: International Publication No. WO 2017/039704

### SUMMARY

In the above-described load sensor, it is desirable that load detection sensitivity is as high as possible. In the configuration of the load sensor disclosed in PTL 1, for example, the load detection sensitivity can be enhanced by adjusting the material of the conductive elastic body, but the selection of the material is limited.

In view of such a problem, an object of the present disclosure is to provide a load sensor capable of enhancing load detection sensitivity with a simple configuration.

A load sensor according to a main aspect of the present disclosure includes a conductive elastic member, a conductive member disposed on the conductive elastic member, and a dielectric material interposed between the conductive elastic member and the conductive member. The conductive elastic member including a surface has an uneven shape, the surface is opposite to a surface on which the conductive member is disposed.

In the load sensor according to the present aspect, the conductive elastic member has an uneven shape on the surface opposite to the surface on which the conductive member is disposed. Thus, the conductive elastic member is likely to be softly deformed so as to wrap the conductive member when a load is applied. Thus, the electrostatic capacitance between the conductive member and conductive elastic member is likely to change when a load is applied, and the load detection sensitivity can be enhanced.

In this manner, the present disclosure can provide a load sensor capable of enhancing load detection sensitivity with a simple configuration.

Effects and meanings of the present disclosure will be further clarified by the following description of exemplary embodiments. However, the exemplary embodiments described below are merely examples of implementing the present disclosure, and the present disclosure is never limited to what is described in the following exemplary embodiments.

### BRIEF DESCRIPTION OF THE DRAWINGS

FIG. 1 is an exploded perspective view schematically illustrating a configuration of a load sensor according to an exemplary embodiment;

FIG. 2A is a side view schematically illustrating a configuration of a base member according to the exemplary embodiment;

FIG. 2B is a bottom view schematically illustrating a configuration of the base member according to the load sensor of the exemplary embodiment;

FIG. 2C is a diagram schematically illustrating a method for forming an uneven shape with respect to the base member according to the load sensor of the exemplary embodiment;

FIG. 3A is a perspective view illustrating a state in which a plurality of conductive elastic bodies and a plurality of conductor lines are overlapped with the base member according to the load sensor of the exemplary embodiment;

FIG. 3B is a perspective view schematically illustrating a state in which a base member is further installed in the structure of FIG. 3A;

FIG. 4A is a diagram schematically illustrating a section of the load sensor according to the exemplary embodiment when the load sensor is cut along a plane parallel to a Y-Z plane at a central position of a conductive elastic body in an X-axis direction;

FIG. 4B is a diagram schematically illustrating a section of the load sensor according to the exemplary embodiment when the load sensor is cut along a plane parallel to a Y-Z plane at a central position of a conductive elastic body in an X-axis direction;

FIG. 5A is a diagram schematically illustrating a section of a load sensor according to Comparative Example 1 when the load sensor is cut along a plane parallel to a Y-Z plane at a central position of a conductive elastic body in an X-axis direction;

FIG. 5B is a diagram schematically illustrating a section of a load sensor according to Comparative Example 2 when the load sensor is cut along a plane parallel to a Y-Z plane at a central position of a conductive elastic body in an X-axis direction;

FIG. 6A is a diagram illustrating each parameter used for simulation in verification 1 according to the load sensor of the exemplary embodiment;

FIG. 6B is a graph illustrating a simulation result of verification 1 according to the load sensor of the exemplary embodiment;

FIG. 7A is a graph illustrating a simulation result of verification 2 according to the load sensor of the exemplary embodiment;

FIG. 7B is a graph illustrating a simulation result of verification 2 according to the load sensor of the exemplary embodiment;

FIG. 7C is a graph illustrating a simulation result of verification 2 according to the load sensor of the exemplary embodiment;

FIG. 8A is a bottom view schematically illustrating an arrangement pattern of an uneven structure used in verification 3 according to the load sensor of the exemplary embodiment;

FIG. 8B is a bottom view schematically illustrating an arrangement pattern of an uneven structure used in verification 3 according to the load sensor of the exemplary embodiment;

FIG. 8C is a graph illustrating a simulation result of verification 3 according to the load sensor of the exemplary embodiment;

FIG. 9A is a diagram schematically illustrating a condition of a positional relationship between a conductor line and an uneven structure used in verification 4 according to the load sensor of the exemplary embodiment;

FIG. 9B is a diagram schematically illustrating a condition of a positional relationship between the conductor line and the uneven structure used in verification 4 according to the load sensor of the exemplary embodiment;

FIG. 9C is a graph illustrating a simulation result of verification 4 according to the load sensor of the exemplary embodiment;

FIG. 10A is a diagram illustrating each parameter used for simulation in verification 5 according to the load sensor of the exemplary embodiment;

FIG. 10B is a graph illustrating a simulation result of verification 5 according to the load sensor of the exemplary embodiment;

FIG. 11A is a diagram illustrating each parameter used for simulation in verification 6 according to the load sensor of the exemplary embodiment;

FIG. 11B is a graph illustrating a simulation result of verification 6 according to the load sensor of the exemplary embodiment;

FIG. 12 is an exploded perspective view schematically illustrating a configuration of a load sensor of Modification Example 1;

FIG. 13 is an exploded perspective view schematically illustrating a configuration of a load sensor of Modification Example 2;

FIG. 14A is a diagram schematically illustrating a section of the load sensor according to Modification Example 2 when the load sensor is cut along a plane parallel to a Y-Z plane at a central position of a conductive elastic body in an X-axis direction;

FIG. 14B is a diagram schematically illustrating a section of the load sensor according to Modification Example 2 when the load sensor is cut along a plane parallel to a Y-Z plane at a central position of a conductive elastic body in an X-axis direction;

FIG. 15A is a perspective view illustrating a configuration of the base member on which a conductive member and a conductive elastic body are disposed according to a load sensor of Modified Example 3; and

FIG. 15B is a perspective view illustrating a configuration of a base member on which a conductive member and a conductive elastic body are disposed according to the load sensor of Modified Example 3.

### DETAILED DESCRIPTIONS

The present disclosure is applicable to an input unit for performing input according to a load applied to an apparatus. Specifically, the present disclosure is applicable to an input unit of an electronic device such as a PC keyboard, an input unit of a game controller, a surface layer part for a robot hand to detect an object, an input unit for inputting volume, air volume, light quantity, temperature, and the like, an input unit of a wearable device such as a smartwatch, an input unit of a hearable device such as wireless earphones, an input unit of a touch panel, an input unit for adjusting the amount of ink and the like in an electronic pen, an input unit for adjusting light quantity, color, and the like in a penlight, an input unit for adjusting light quantity and the like in shining clothes, an input unit for adjusting volume and the like in a musical instrument, and the like.

The following exemplary embodiment is a load sensor typically provided in apparatuses as described above. Such a load sensor may be referred to as “electrostatic capacitance type pressure-sensitive sensor element”, “capacitive pressure detection sensor element”, “pressure-sensitive switch element”, or the like. The following exemplary embodiment is an exemplary embodiment of the present disclosure, and the present disclosure is not limited to the following exemplary embodiment at all.

Hereinafter, an exemplary embodiment (hereinafter, the present exemplary embodiment) of the present disclosure will be described with reference to the drawings. For the sake of convenience, X, Y, and X axes perpendicular to each other are added to the drawings. A direction of the Z axis is a height direction of a load sensor.

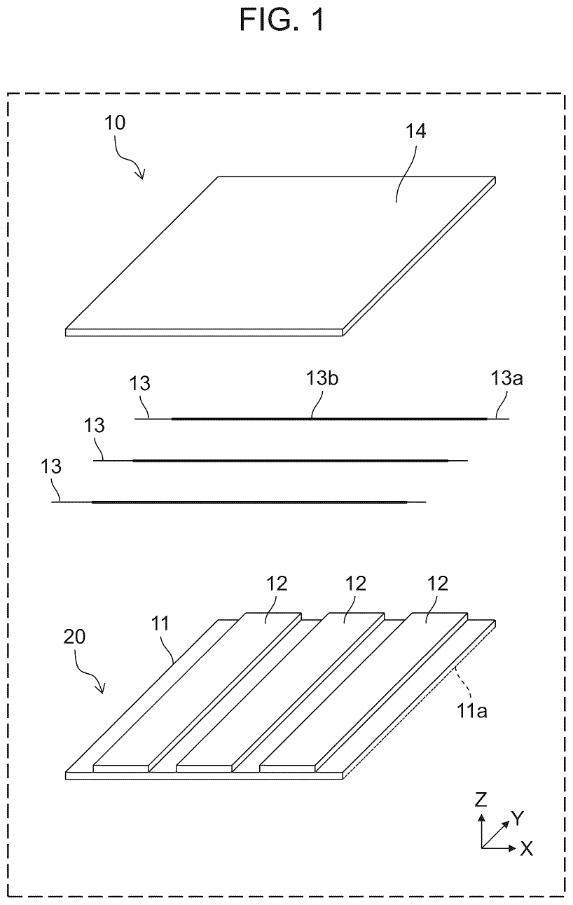

FIG. 1 is an exploded perspective view schematically illustrating a configuration of load sensor 10 according to the present exemplary embodiment.

As illustrated in FIG. 1, load sensor 10 includes base member 11, a plurality of conductive clastic bodies 12, a plurality of conductor lines 13, and base member 14. Base member 11 and the plurality of conductive elastic bodies 12 disposed on the upper surface of base member 11 constitute conductive clastic member 20.

Base member 11 is an insulating flat plate-like member having elasticity. Base member 11 has a rectangular shape in plan view. The thickness of base member 11 is constant. The thickness of base member 11 is, for example, 0.01 mm to 2 mm. When the thickness of base member 11 is small, base member 11 may be referred to as a sheet member or a film member. Base member 11 is made of a non-conductive resin material or a non-conductive rubber material.

The resin material used for base member 11 is, for example, at least one resin material selected from the group consisting of a styrene-based resin, a silicone-based resin (for example, polydimethylpolysiloxane (PDMS)), an acryl-based resin, a rotaxane-based resin, a urethane-based resin, and the like. The rubber material used for base member 11 is, for example, at least one rubber material selected from the group consisting of silicone rubber, isoprene rubber, butadiene rubber, styrene-butadiene rubber, chloroprene rubber, nitrile rubber, polyisobutylene, ethylene propylene rubber, chlorosulfonated polyethylene, acrylic rubber, fluororubber, epichlorohydrin rubber, urethane rubber, natural rubber, and the like.

Base member 11 has uneven shape 11a on the surface (a surface facing in the negative direction of the Z axis, hereinafter referred to as “surface on the negative side of the Z axis”) opposite to the surface (a surface facing in the positive direction of the Z axis, referred to as “surface on the positive side of the Z axis”) on which conductor line 13 is disposed. Here, uneven shape 11a includes a plurality of ridges parallel to each other. The plurality of ridges extend in a direction (Y-axis direction) in which conductor line 13 extends.

Hereinafter, “facing in the positive direction of the Z axis” or “being positioned on the positive side of the Z axis” with respect to an object is referred to as “being on the positive side of the Z axis”, and “facing in the negative direction of the Z axis” or “being positioned on the negative side the Z axis” is referred to as “being on the negative side of the Z axis”. Similarly, “facing in the positive direction of the X axis” or “being positioned on the positive side of the X axis” with respect to an object is referred to as “being on the positive side of the X axis”, and “facing in the negative direction of the X axis” or “being positioned on the negative side the X axis” is referred to as “being on the negative side of the X axis”. “Facing in the positive direction of the Y axis” or “being positioned on the positive side of the Y axis” with respect to an object is referred to as “being on the positive side of the Y axis”, and “facing in the negative direction of the Y axis” or “being positioned on the negative side the Y axis” is referred to as “being on the negative side of the Y axis”.

Conductive elastic body 12 is disposed on the upper surface (surface on the positive side of the Z axis) of base member 11. In FIG. 1, three conductive elastic bodies 12 are disposed on the upper surface of base member 11. Conductive elastic body 12 is a conductive member having elasticity. Each conductive elastic body 12 has a belt-like shape elongated in the Y-axis direction. The three conductive elastic bodies 12 are arranged side by side at a predetermined interval in the X-axis direction.

Conductive elastic body 12 is formed on the upper surface of base member 11 by any printing method such as screen printing, gravure printing, flexographic printing, offset printing, or gravure offset printing. According to these printing methods, conductive elastic body 12 can be formed with a thickness of about 0.001 mm to 0.5 mm on the upper surface of base member 11.

Conductive clastic body 12 includes a resin material and a conductive filler dispersed in the resin material, or a rubber material and a conductive filler dispersed in the rubber material.

Similarly to the resin material used for base member 11 described above, the resin material used for conductive elastic body 12 is, for example, at least one resin material selected from the group consisting of a styrene-based resin, a silicone-based resin (polydimethylpolysiloxane (for example, PDMS), and the like), an acryl-based resin, a rotaxane-based resin, a urethane-based resin, and the like.

Similarly to the rubber material used for base member 11 described above, the rubber material used for conductive elastic body 12 is, for example, at least one rubber material selected from the group consisting of silicone rubber, isoprene rubber, butadiene rubber, styrene-butadiene rubber, chloroprene rubber, nitrile rubber, polyisobutylene, ethylene propylene rubber, chlorosulfonated polyethylene, acrylic rubber, fluororubber, epichlorohydrin rubber, urethane rubber, natural rubber, and the like.

The conductive filler used for conductive clastic body 12 is, for example, at least one material selected from the group consisting of metallic materials such as Au (gold), Ag (silver), Cu (copper), C (carbon), ZnO (zinc oxide), In₂O₃ (indium oxide (III)), and SnO₂ (tin oxide (IV)), conductive polymer materials such as PEDOT: PSS (that is, a composite formed of poly (3,4-ethylenedioxythiophene) (PEDOT) and polystyrene sulfonic acid (PSS)), and conductive fibers such as metal-coated organic fibers and metal wires (fiber state).

Conductor line 13 is a linear member and is disposed to overlap the upper surface of conductive elastic body 12. In the present exemplary embodiment, three conductor lines 13 are disposed to overlap the upper surfaces of three conductive elastic bodies 12. Three conductor lines 13 are arranged side by side at a predetermined interval in a longitudinal direction (Y-axis direction) of conductive elastic body 12 so as to intersect conductive clastic body 12. Each conductor line 13 is disposed so as to extend in the X-axis direction across three conductive clastic bodies 12.

Conductor line 13 is, for example, a coated copper wire. Conductor line 13 includes linear conductive member 13a and dielectric material 13b formed on the surface of conductive member 13a. Conductive member 13a is a linear member having conductivity. Dielectric material 13b covers the surface of conductive member 13a. Conductive member 13a is made of, for example, copper. The diameter of conductive member 13a is, for example, about 60 μm. Conductive member 13a may be made of a stranded wire.

Dielectric material 13b has electrical insulation, and is made of, for example, a resin material, a ceramic material, a metal oxide material, or the like. Dielectric material 13b may be at least one resin material selected from the group consisting of a polypropylene resin, a polyester resin (for example, polyethylene terephthalate resin), a polyimide resin, a polyphenylene sulfide resin, a polyvinyl formal resin, a polyurethane resin, a polyamideimide resin, a polyamide resin, and the like, or may be at least one metal oxide material selected from the group consisting of Al₂O₃, Ta₂O₅, and the like. Dielectric material 13b is formed at least in a range overlapping conductive clastic body 12 of conductor line 13.

Base member 14 is an insulating member. Base member 14 is, for example, at least one resin material selected from the group consisting of polyethylene terephthalate, polycarbonate, polyimide, and the like. Base member 14 may be made of the same material as base member 11. Base member 14 has a flat plate-like shape parallel to the X-Y plane, and has the same size and shape as base member 11 in plan view. The thickness of base member 14 in the Z-axis direction is, for example, 0.01 mm to 2 mm.

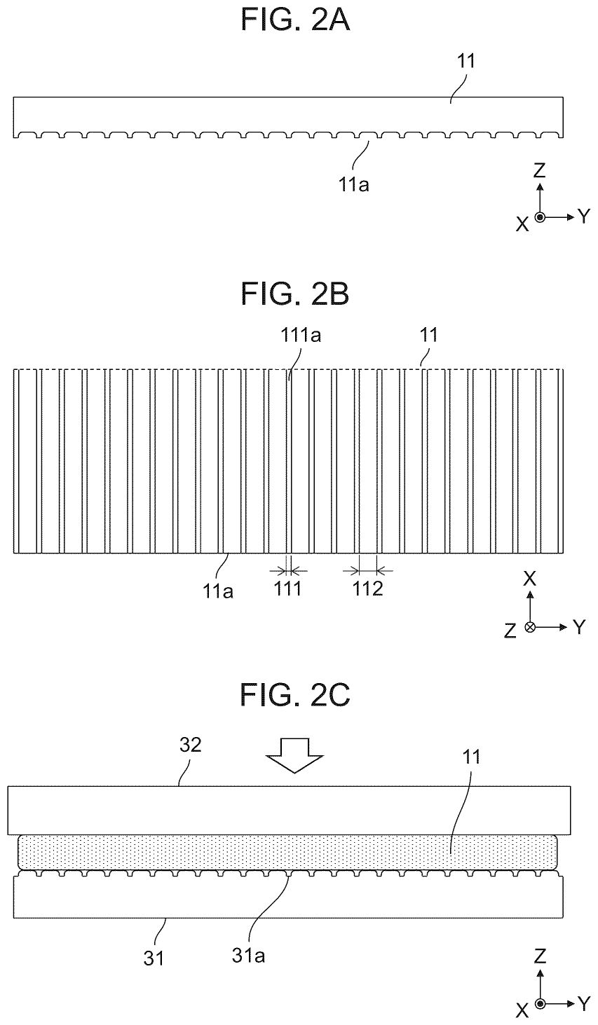

FIG. 2A is a side view schematically illustrating a configuration of base member 11 according to the load sensor of the present exemplary embodiment. FIG. 2B is a bottom view schematically illustrating a configuration of base member 11 according to the load sensor of the present exemplary embodiment. FIG. 2B illustrates a portion of base member 11 on the negative side of the Z axis.

As illustrated in FIGS. 2A and 2B, uneven shape 11a includes a plurality of ridges 111 extending in the X-axis direction and recess 112 between adjacent ridges 111. An end of ridge 111 is flat face 111a substantially parallel to the X-Y plane. The pitch of ridges 111 in the Y-axis direction is substantially constant, and the pitch of recesses 112 in the Y-axis direction is substantially constant. The width of ridge 111 in the Y-axis direction is substantially constant, and the width of recess 112 in the Y-axis direction is substantially constant.

FIG. 2C is a diagram schematically illustrating a method for forming uneven shape 11a with respect to base member 11 according to the load sensor of the present exemplary embodiment.

As illustrated in FIG. 2C, base member 11 in a soft state before solidification is placed on plate 31 having transfer pattern 31a with uneven shape 11a. Further, pressing plate 32 is placed on the upper surface of base member 11 opposite from plate 31, and a downward pressure is applied to pressing plate 32. As a result, the lower portion of base member 11 enters transfer pattern 31a, and uneven shape 11a corresponding to transfer pattern 31a is formed on the lower surface of base member 11. Thereafter, a step of solidifying base member 11 such as a cooling step is performed. After this step, base member 11 is peeled off from plate 31. As a result, base member 11 having uneven shape 11a on the lower surface is formed.

The method for forming uneven shape 11a is not limited to this method. For example, instead of plate 31, base member 11 may be pressed against cloth in which threads are stretched in a mesh shape to form uneven shape 11a on the lower surface of base member 11. In this case, uneven shape 11a is configured such that a large number of protrusions corresponding to the mesh are distributed. Alternatively, instead of the method of pressing base member 11 against plate 31 or cloth, base member 11 having uneven shape 11a may be formed by a method such as injection molding.

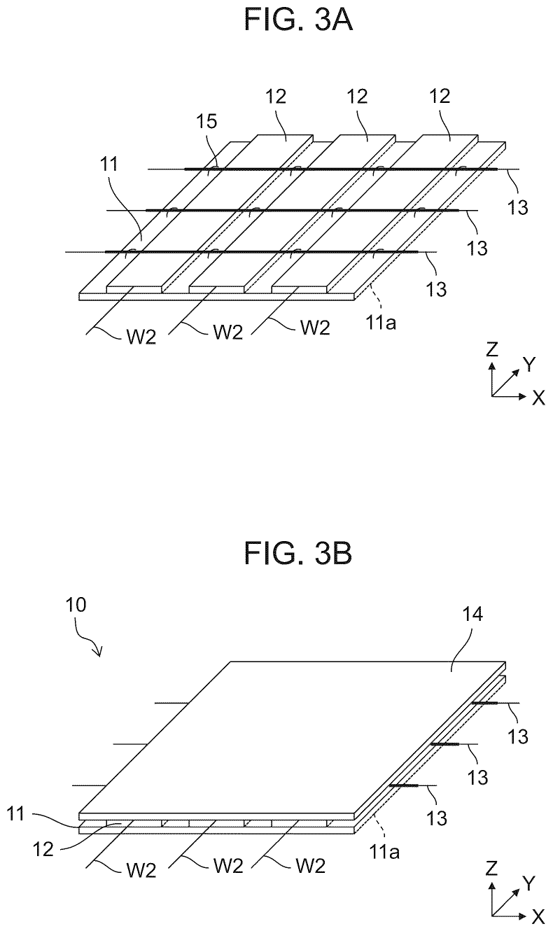

FIG. 3A is a perspective view illustrating a state in which a plurality of conductive clastic bodies 12 and a plurality of conductor lines 13 are overlapped with base member 11 according to the load sensor of the present exemplary embodiment.

As described above, three conductive elastic bodies 12 are disposed on the upper surface of base member 11 through a printing step. Further, wiring W2 electrically connected to conductive elastic body 12 is installed at an end of each conductive elastic body 12 on the negative side of the Y axis.

Three conductor lines 13 are disposed on the upper surfaces of three conductive elastic bodies 12. Each conductor line 13 is connected to base member 11 with thread 15 so as to be movable in the longitudinal direction (X-axis direction) of conductor line 13. In the example illustrated in FIG. 3A, 12 threads 15 connect conductor lines 13 to base member 11 at positions other than the position where conductive elastic body 12 and conductor line 13 overlap. Thread 15 is made of chemical fibers, natural fibers, or mixed fibers thereof.

FIG. 3B is a perspective view schematically illustrating a state in which base member 14 is installed in the structure of FIG. 3A.

Base member 14 is installed from above (from the positive side of the Z axis) the structure illustrated in FIG. 3A. The four outer peripheral sides of base member 14 are connected to the four outer peripheral sides of base member 11 with a silicone rubber-based adhesive, a thread, or the like. As a result, base member 14 is fixed to base member 11. Conductor line 13 is sandwiched between conductive elastic body 12 and base member 14. Load sensor 10 is thus completed as illustrated in FIG. 3B.

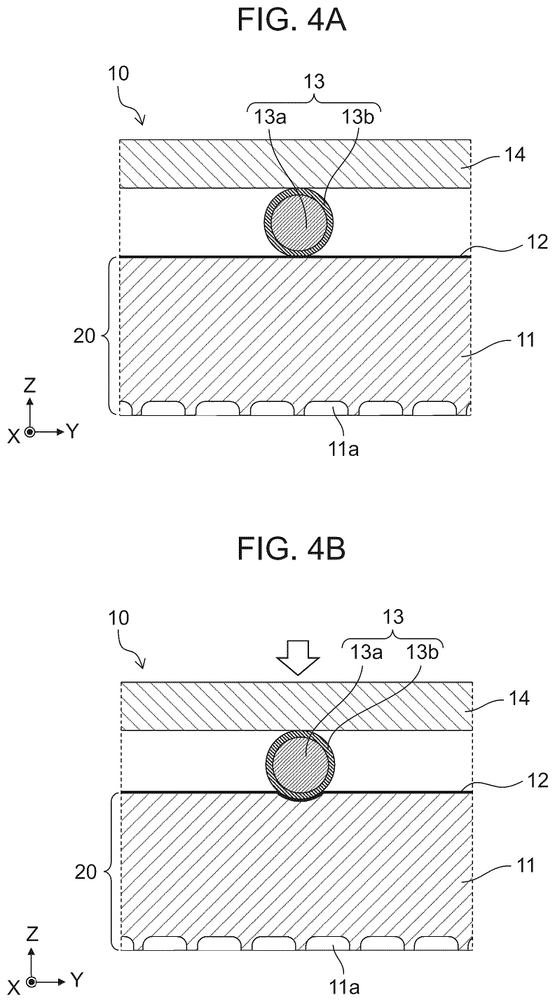

Each of FIGS. 4A and 4B is a diagram schematically illustrating a section of load sensor 10 of the present exemplary embodiment when load sensor 10 is cut along a plane parallel to the Y-Z plane at a central position of conductive elastic body 12 in the X-axis direction. FIG. 4A illustrates a state in which no load is applied, and FIG. 4B illustrates a state in which a load is applied.

As illustrated in FIG. 4A, in a state where no load is applied, the force applied between conductive elastic body 12 and conductor line 13 and the force applied between base member 14 and conductor line 13 are substantially 0. From this state, as illustrated in FIG. 4B, when a load is applied to the surface of base member 14 on the positive side of the Z axis, conductive elastic body 12 is deformed by conductor line 13.

As illustrated in FIG. 4B, conductor line 13 is brought close to conductive clastic body 12 so as to be wrapped by conductive clastic body 12 with application of the load. Accordingly, the contact area between conductor line 13 and conductive elastic body 12 increases. As a result, the electrostatic capacitance between conductive member 13a and conductive elastic body 12 changes. By detecting the electrostatic capacitance between conductive member 13a and conductive elastic body 12, the load applied to this region is acquired.

As illustrated in FIGS. 1, 3A, and 3B, in the present exemplary embodiment, three conductive elastic bodies 12 and three conductor lines 13 are disposed so as to intersect each other. Thus, the intersection positions of three conductive elastic bodies 12 and three conductor lines 13 are distributed in a matrix shape in plan view, and there are a total of nine intersection positions. A load can be detected at each intersection position based on electrostatic capacitance. That is, 9 element parts capable of detecting a load are distributed in a matrix in load sensor 10.

Here, in the present exemplary embodiment, for example, as illustrated in FIGS. 4A and 4B, base member 11 has uneven shape 11a on the surface opposite to the surface on which conductor line 13 (conductive member 13a) is disposed. Thus, when a load is applied as illustrated in FIG. 4B, base member 11 is likely to be softly deformed so as to wrap conductor line 13. As a result, the electrostatic capacitance between conductive member 13a and conductive elastic body 12 is likely to change when a load is applied, and the load detection sensitivity can be enhanced.

### Verification 1

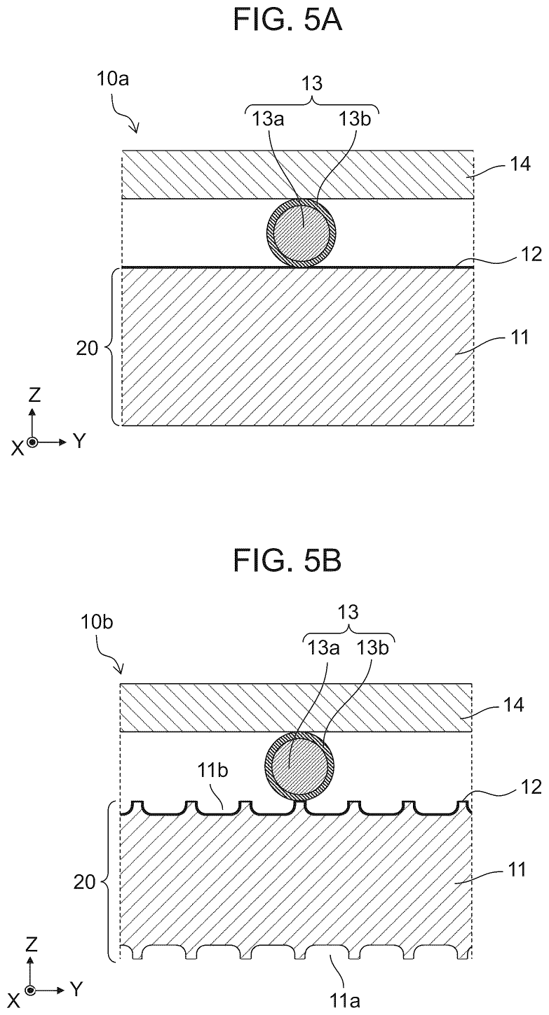

The inventors of the present disclosure verified, through a simulation, the effect obtained by forming uneven shape 11a in base member 11 as described above. As a comparison, the configurations (load sensors 10a, 10b) of Comparative Examples 1 and 2 illustrated in FIGS. 5A and 5B were also verified. FIG. 5A is a diagram schematically illustrating a section of load sensor 10a according to Comparative Example 1 when load sensor 10a is cut along a plane parallel to a Y-Z plane at a central position of a conductive clastic body in the X-axis direction. FIG. 5B is a diagram schematically illustrating a section of load sensor 10b according to Comparative Example 2 when load sensor 10b is cut along a plane parallel to a Y-Z plane at a central position of a conductive elastic body in the X-axis direction. In Comparative Example 1 of FIG. 5A, uneven shape 11a is omitted. In Comparative Example 2 of FIG. 5B, together with uneven shape 11a, uneven shape 11b is formed in the same pattern as uneven shape 11a on the surface of base member 11 facing conductor line 13 (conductive member 13a). Other configurations in Comparative Examples 1 and 2 are the same as the configurations of the exemplary embodiment illustrated in FIGS. 4A and 4B.

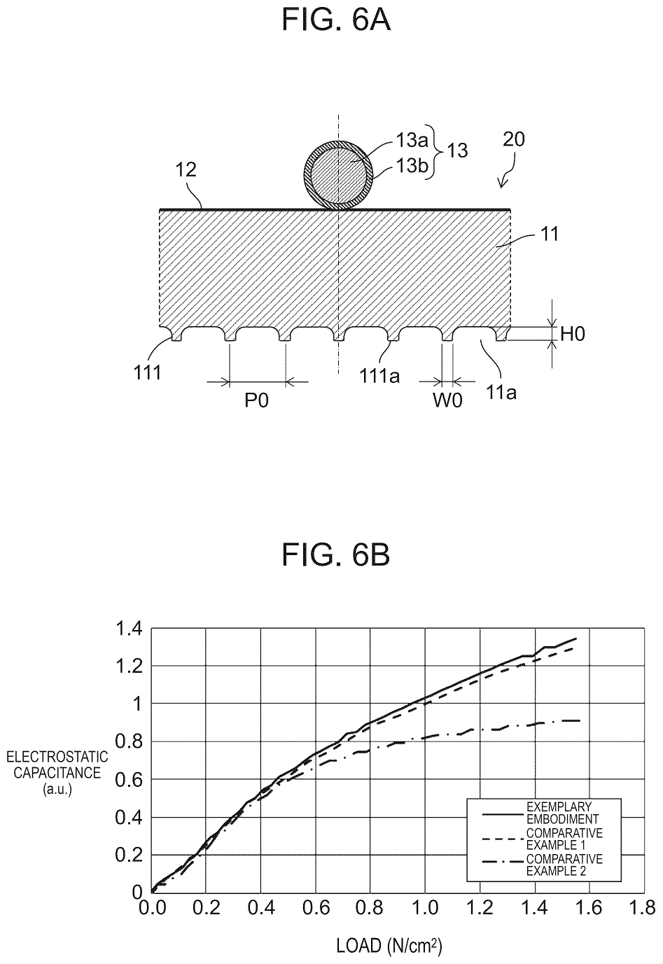

FIG. 6A is a diagram illustrating each parameter used for simulation in verification 1 according to the load sensors of Comparative Example 1, Comparative Example 2, and the present exemplary embodiment.

H0 is the height of uneven shape 11a (height of ridge 111), WO is the width of flat face 111a, and P0 is the pitch between ridges 111. In verification 1, height H0, width W0, and pitch P0 were set to 0.06 mm, 0.05 mm, and 0.24 mm, respectively. Conductor line 13 was disposed directly above ridge 111. In Comparative Example 2 of FIG. 5B, both uneven shapes 11a and 11b were set under the same conditions as described above. The thickness of base member 11 was set to 0.5 mm, and the thickness of conductive elastic body 12 was set to 0.0118 μm. The conditions for setting the thicknesses of base member 11 and conductive elastic body 12 are the same in verification 2 and other verifications to be described later.

Under the above conditions, with respect to one intersection position of conductor line 13 and conductive clastic body 12, a change in electrostatic capacitance with respect to a load was obtained through a simulation. Here, the load was changed in the range of 0 N/cm² to 1.6 N/cm².

FIG. 6B is a graph illustrating a simulation result of verification 1 according to the load sensor of the present exemplary embodiment.

In FIG. 6B, the horizontal axis represents the load applied to load sensors 10, 10a, and 10b, and the vertical axis represents the electrostatic capacitance between conductive member 13a and conductive elastic body 12 when each load is applied. The vertical axis is normalized by a predetermined value.

As illustrated in FIG. 6B, when uneven shape 11a is formed on the surface of base member 11 opposite to the surface on which conductor line 13 is disposed as in the above-described exemplary embodiment, the electrostatic capacitance with respect to the same load has increased, and the electrostatic capacitance detection sensitivity has been enhanced as compared with the configuration of Comparative Example 1 in which uneven shape 11a is not formed. As a result, the effect of improving the load detection sensitivity with uneven shape 11a has been confirmed.

As illustrated in FIG. 6B, in the configuration of Comparative Example 2 in which, in addition to the uneven shape 11a, uneven shape 11b was formed on the surface on which conductor line 13 is overlapped, the detection sensitivity was lower than that in Comparative Example 1. This is considered to be because the contact area between conductive elastic body 12 and conductor line 13 is less likely to increase with an increase in load because uneven shape 11b is disposed as illustrated in FIG. 5B.

### Verification 2

Next, the inventors of the present disclosure verified, through a simulation, changes in the load detection sensitivity when height H0, width W0, and pitch P0 in FIG. 6A were changed in the configuration of the exemplary embodiment. Here, the detection sensitivity was obtained for seven types having different heights H0, widths W0, and pitches P0. The values of height H0, width W0, and pitch P0 in each type were set as listed in Table 1 shown below.

TABLE 1

| | Width W0 | Height H0 | Pitch P0 |
|---|---|---|---|
| Type | (mm) | (mm) | (mm) |
| 1 | 0.1 | 0.1 | 0.5 |
| 2 | 0.1 | 0.1 | 0.25 |
| 3 | 0.1 | 0.1 | 1 |
| 4 | 0.1 | 0.05 | 0.5 |
| 5 | 0.1 | 0.2 | 0.5 |
| 6 | 0.05 | 0.1 | 0.5 |
| 7 | 0.2 | 0.1 | 0.5 |

Here, any one of height H0, width W0, and pitch P0 in types 2 to 7 is changed based on type 1. That is, in types 2 and 3, pitch P0 was changed with respect to type 1. In types 4 and 5, height H0 was changed with respect to type 1. In types 6 and 7, width W0 was changed with respect to type 1.

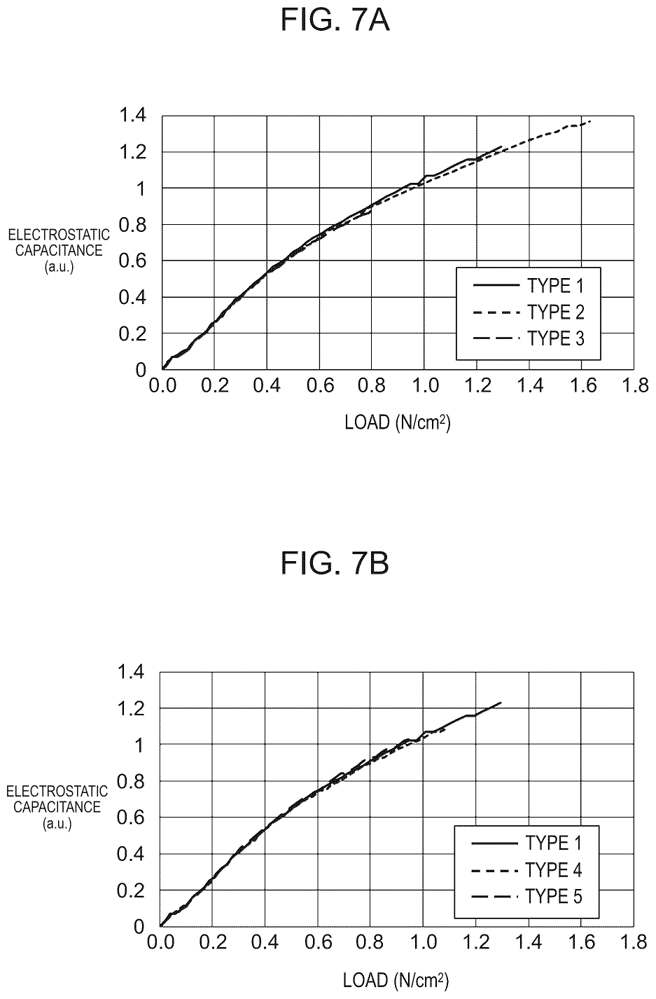

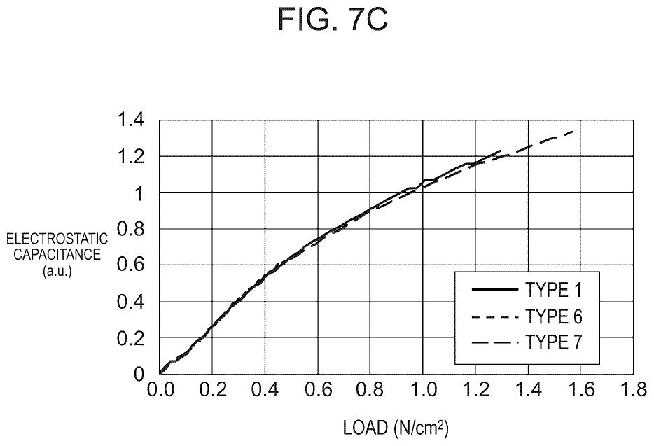

Each of FIGS. 7A, 7B, and 7C is a graph illustrating a simulation result of verification 2 according to the load sensor of the present exemplary embodiment.

FIG. 7A is a simulation result in a case where pitch PO is changed, FIG. 7B is a simulation result in a case where height H0 is changed, and FIG. 7C is a simulation result in a case where width W0 is changed. In each drawing, the horizontal axis represents the load applied to load sensor 10, and the vertical axis represents the electrostatic capacitance between conductive member 13a and conductive elastic body 12 when each load is applied. The vertical axis is normalized by a predetermined value.

As illustrated in FIGS. 7A to 7C, even when pitch P0, height H0, or width W0 was changed in the range of Table 1, the sensitivity characteristic of load sensor 10 hardly changed. From this, it has been confirmed that by forming uneven shape 11a on base member 11, the detection sensitivity of the load can be enhanced regardless of the variation at the time of creating load sensor 10.

### Verification 3

Next, the inventors of the present disclosure verified, through a simulation, a change in load detection sensitivity when the arrangement pattern of uneven shape 11a was changed in the configuration of the present embodiment.

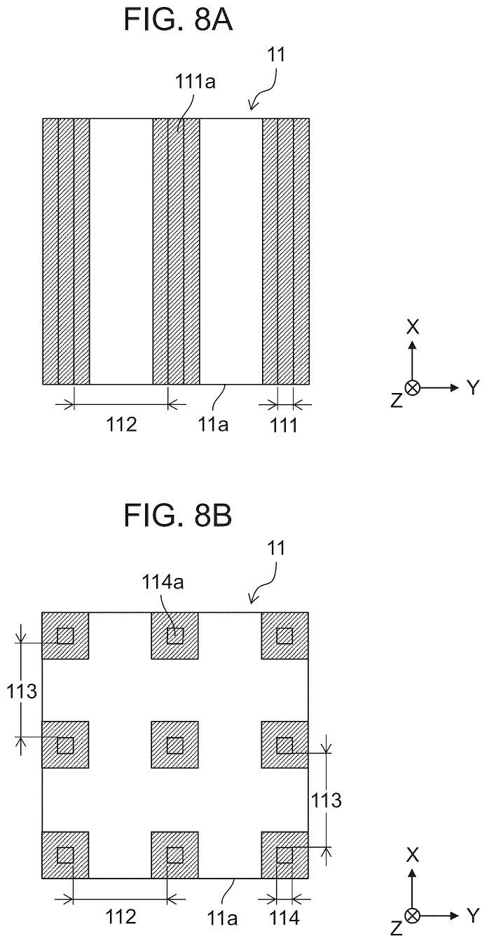

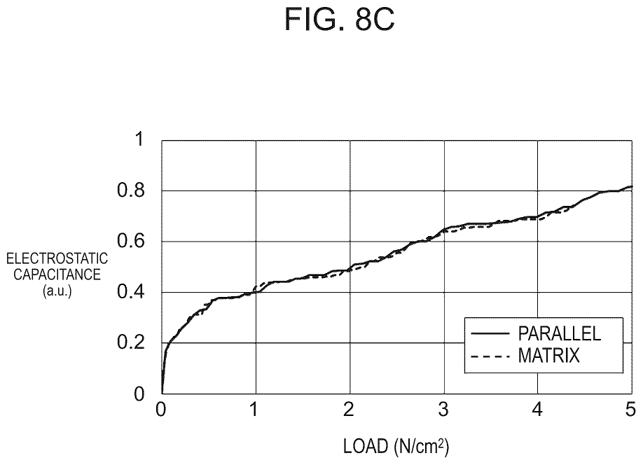

Each of FIGS. 8A and 8B is a bottom view schematically illustrating an arrangement pattern of uneven shape 11a used in verification 3 for the load sensor of the present exemplary embodiment.

The arrangement pattern of FIG. 8A is similar to the arrangement pattern in the above exemplary embodiment. Here, three ridges 111 parallel to each other are disposed at substantially the same pitch. The width of each ridge 111 in the Y-axis direction is substantially constant, and the width of each recess 112 in the Y-axis direction is substantially constant.

In the arrangement pattern of FIG. 8B, ridges 111 of FIG. 8A are cut out by recesses 113 similar to recesses 112 to form a plurality of protrusions 114. Each recess 113 extends in the Y-axis direction. The pitch between recesses 113 in the X-axis direction is constant and is equal to the pitch between recesses 112 in the Y-axis direction. Thus, nine protrusions 114 are arranged in a matrix at the same pitch in the X-axis direction and the Y-axis direction. The end of each protrusion 114 is flat face 114a substantially parallel to the X-Y plane.

In the simulation, a change in electrostatic capacitance with respect to a change in load caused when conductive clastic body 12 illustrated in FIG. 6A was replaced with conductive clastic body 12 illustrated in FIGS. 8A and 8B was obtained. Here, the condition of the simulation is that conductor line 13 is disposed directly above ridge 111 or protrusion 114 at the center in the Y-axis direction. Height H0, width W0, and pitch P0 of ridge 111 and protrusion 114 were set to 0.1 mm, 0.1 mm, and 0.5 mm, respectively.

FIG. 8C is a graph illustrating a simulation result of verification 3 according to the load sensor of the present exemplary embodiment.

In FIG. 8C, a solid line graph indicates the sensitivity characteristic in the case of the arrangement pattern of FIG. 8A, and a broken line graph indicates the sensitivity characteristic in the case of the arrangement pattern of FIG. 8B. In FIG. 8C, the horizontal axis represents the load applied to load sensor 10, and the vertical axis represents the electrostatic capacitance between conductive member 13a and conductive elastic body 12 when each load is applied. The vertical axis is normalized by a predetermined value.

As illustrated in FIG. 8C, there was almost no difference in sensitivity characteristic between the arrangement patterns of FIGS. 8A and 8B. From this, it has been confirmed that substantially similar sensitivity characteristics can be obtained between the case where uneven shape 11a is the parallel arrangement of ridges 111 as illustrated in FIG. 8A and the case where uneven shape 11a is the matrix arrangement of protrusions 114 as illustrated in FIG. 8B.

### Verification 4

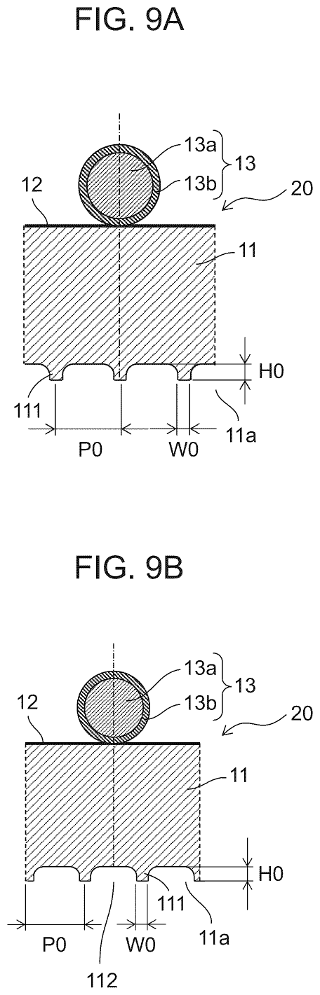

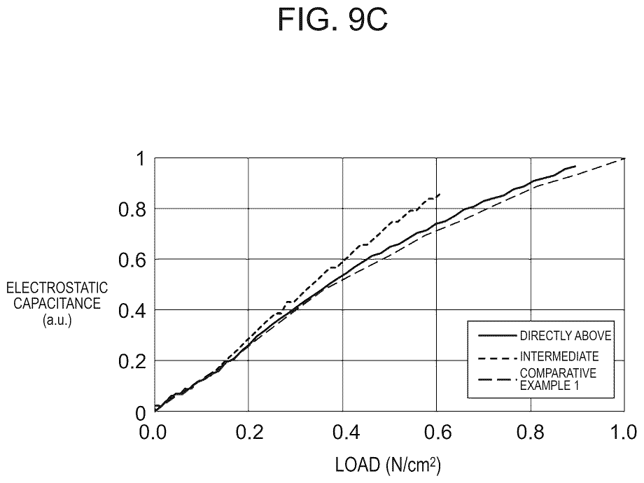

Next, the inventors of the present disclosure verified, through a simulation, a change in load detection sensitivity when the positional relationship between conductor line 13 (conductive member 13a) and uneven shape 11a was changed. FIG. 9A is a diagram schematically illustrating a condition of a positional relationship between a conductor line and an uneven structure used in verification 4 according to the load sensor of the present exemplary embodiment. FIG. 9B is a diagram schematically illustrating a condition of a positional relationship between the conductor line and the uneven structure used in verification 4 according to the load sensor of the present exemplary embodiment. Here, the electrostatic capacitance with respect to each load was obtained through a simulation for the case where conductor line 13 was disposed directly above ridge 111 as illustrated in FIG. 9A and the case where conductor line 13 was disposed directly above the intermediate position (intermediate position of recess 112) of adjacent ridge 111 as illustrated in FIG. 9B. Width W0, height H0, and pitch P0 of ridge 111 were set to 0.1 mm, 0.2 mm, and 1 mm, respectively.

FIG. 9C is a graph illustrating a simulation result of verification 4 according to the load sensor of the present exemplary embodiment.

In FIG. 9C, a solid line graph indicates the sensitivity characteristic obtained with the arrangement of FIG. 9A, and a broken line graph indicates the sensitivity characteristic obtained with the arrangement of FIG. 9B. For comparison, the sensitivity characteristic (long dashed line) obtained with the configuration of Comparative Example 1 in FIG. 5A is included in FIG. 9C. In FIG. 9C, the horizontal axis represents the load applied to load sensor 10, and the vertical axis represents the electrostatic capacitance between conductive member 13a and conductive elastic body 12 when each load is applied. The vertical axis is normalized by a predetermined value.

As illustrated in FIG. 9C, when conductor line 13 (conductive member 13a) was disposed directly above the intermediate position between adjacent ridges 111, the sensitivity characteristic further improved as compared with the case where conductor line 13 (conductive member 13a) was disposed directly above ridges 111. This is considered to be because, when recess 112 is present below conductor line 13 (conductive member 13a), conductive elastic body 12 is likely to be elastically deformed at the arrangement position of conductor line 13 when a load is applied, and thus conductor line 13 is likely to be wrapped by the upper surface of conductive elastic body 12.

Thus, it can be said that when load sensor 10 is configured such that conductor line 13 (conductive member 13a) is overlapped with conductive elastic body 12 at a position of recess 112 of uneven shape 11a in plan view, the sensitivity characteristic of load sensor 10 can be more effectively enhanced.

In this case, conductor line 13 (conductive member 13a) is not necessarily disposed at the intermediate position between adjacent ridges 111 (intermediate position between recesses 112), and may be disposed at a position slightly shifted so as to approach a ridge of adjacent ridges 111 from the intermediate position. In addition, also in the configuration of FIG. 8B shown in verification 3, the sensitivity characteristic of load sensor 10 can be more effectively enhanced by arranging conductor line 13 (conductive member 13a) at the position of recess 112 in plan view.

### Verification 5

Next, the inventors of the present disclosure verified, through a simulation, a change in load detection sensitivity when the surface density of flat face 111a was changed.

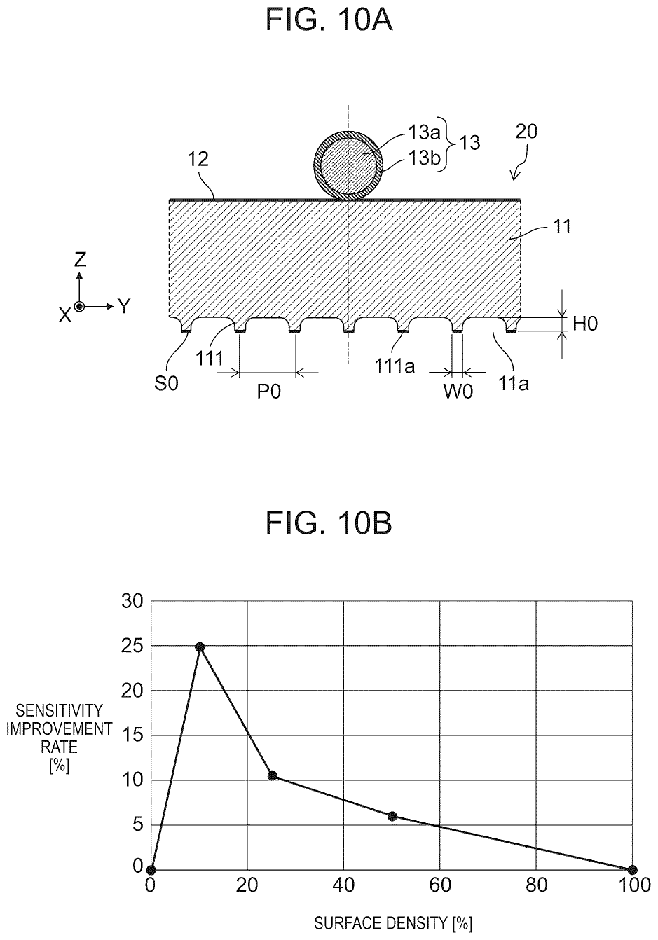

FIG. 10A is a diagram illustrating each parameter used for a simulation regarding surface density according to the load sensor of the present exemplary embodiment.

The surface density is calculated as the surface density of the flat face 111a. That is, when the lower surface of base member 11 is viewed in plan view, the proportion of the total area (sum of areas S0 of flat faces 111a) of flat faces 111a included in a predetermined range to the area of the predetermined range is calculated as the surface density of flat face 111a. More specifically, the area of the predetermined range in a case where the predetermined range is assumed to be a plane parallel to the X-Y plane is acquired. Then, the proportion of the total area (sum of areas S0 of flat faces 111a) of flat faces 111a included in the predetermined range to the area is calculated as the surface density of flat face 111a. Thus, when uneven shape 11a is not formed, the surface density is 100%.

The predetermined range for calculating the surface density may be the entire range in which uneven shape 11a is formed, or may be a part of the entire range. By setting the predetermined range so as to include flat face 111a as much as possible, the calculation accuracy of the surface density can be enhanced. In the simulation, the surface density was calculated with the entire range in which uneven shape 11a was formed as the predetermined range.

In the simulation, height H0 and width W0 of ridge 111 were set to 0.2 mm and 0.1 mm, respectively. Then, the surface density was changed by changing pitch P0 of ridges 111. As illustrated in FIG. 10A, conductor line 13 (conductive member 13a) was disposed directly above ridge 111. For the plurality of surface densities, the sensitivity improvement rate with respect to the configuration of Comparative Example 1 (with no uneven shape 11a) was calculated. The sensitivity improvement rate was calculated from the ratio of the electrostatic capacitance in the exemplary embodiment to the electrostatic capacitance in Comparative Example 1 at a load of 6 N/cm².

FIG. 10B is a graph illustrating a simulation result of verification 5 according to the load sensor of the present exemplary embodiment.

As illustrated in FIG. 10B, the sensitivity improvement rate was higher as the surface density of flat face 111a was lower, that is, as the lower surface of conductive clastic body 12 was coarser. In particular, when the surface density of flat face 111a was about less than or equal to 80%, the sensitivity improvement rate with respect to Comparative Example 1 was more than or equal to 2%, and a remarkable effect of improving the sensitivity of load sensor 10 was obtained. From this, it can be said that the surface density of flat face 111a is preferably about less than or equal to 80%. Under the above conditions, it can be said that the surface density is most preferably around 10%.

Also when the plurality of protrusions 114 are arranged in a matrix as illustrated in FIG. 8B, the surface density of flat face 111a is preferably set to about less than or equal to 80%. As a result, the same effect as described above can be achieved.

### Verification 6

Further, the inventors of the present disclosure verified, through a simulation, a change in load detection sensitivity when the height of uneven shape 11a was changed.

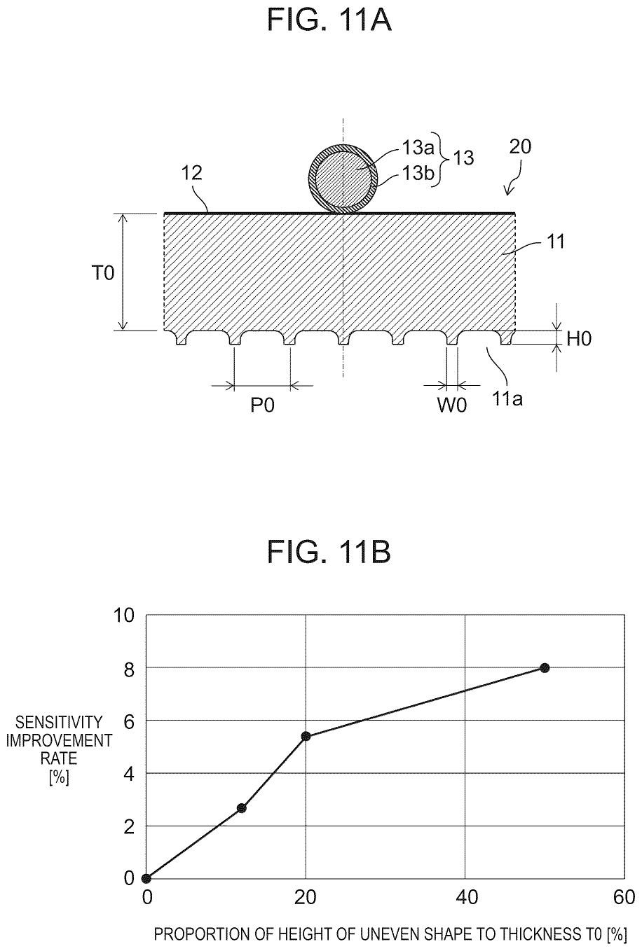

FIG. 11A is a diagram illustrating each parameter used in a simulation regarding the height of uneven shape 11a according to the load sensor of the present exemplary embodiment.

In this simulation, the proportion of height H0 of uneven shape 11a to thickness T0 of the conductive elastic member (base member 11 and conductive elastic body 12) excluding the thickness portion of uneven shape 11a was changed. Height H0 and width W0 of ridge 111 were set to 0.2 mm and 0.1 mm, respectively, as in the case of FIG. 10A. Pitch P0 of ridges 111 was set to a value at which the surface density became 50% in verification 5 of FIG. 10A. As illustrated in FIG. 11A, conductor line 13 (conductive member 13a) was disposed directly above ridge 111. Under these conditions, the proportion of height H0 to thickness T0 was changed to calculate the sensitivity improvement rate for the configuration of Comparative Example 1 (with no uneven shape 11a). The sensitivity improvement rate was calculated by the same method as in verification 5 described above.

FIG. 11B is a graph illustrating a simulation result of verification 6 according the load sensor of the present exemplary embodiment.

As illustrated in FIG. 11B, the sensitivity improvement rate increased as the proportion of height H0 of uneven shape 11a to thickness T0 increased, that is, as the lower surface of conductive elastic body 12 was coarser. In particular, when the proportion of height H0 of uneven shape 11a to thickness T0 was about more than or equal to 10%, the sensitivity improvement rate with respect to Comparative Example 1 was more than or equal to 2%, and a remarkable effect of improving the sensitivity of load sensor 10 was obtained. From this, it can be said that the proportion of height H0 of uneven shape 11a to thickness T0 is preferably about more than or equal to 10%.

Also when a plurality of protrusions 114 are arranged in a matrix as illustrated in FIG. 8B, the proportion of the height of uneven shape 11a to thickness T0 is preferably set to about more than or equal to 10%. As a result, the same effect as described above can be achieved.

### Effect of Exemplary Embodiment

According to the above-described exemplary embodiment, the following effects are exhibited.

As illustrated in FIGS. 1 to 4B, conductive elastic member 20 (base member 11) has uneven shape 11a on the surface opposite to the surface on which conductor line 13 (conductive member 13a) is disposed. With this configuration, when a load is applied, conductive elastic member 20 (base member 11) is likely to be softly deformed so as to wrap conductor line 13 (conductive member 13a). Thus, the electrostatic capacitance between conductive member 13a and conductive clastic body 12 is likely to change when a load is applied, and the load detection sensitivity can be enhanced.

As illustrated in FIGS. 2A and 2B, uneven shape 11a includes a plurality of ridges 111 parallel to each other. As a result, as illustrated in verification 1 of FIGS. 6A and 6B, the load detection sensitivity of load sensor 10 can be enhanced.

As illustrated in FIG. 8B, uneven shape 11a may include a plurality of protrusions 114 arranged in a matrix. With this configuration as well, as shown in verification 3 of FIG. 8C, the load detection sensitivity of load sensor 10 can be enhanced.

As illustrated in FIG. 9B, conductive member 13a is preferably overlapped with conductive elastic member 20 (base member 11, conductive clastic body 12) at a position of recess 112 of uneven shape 11a in plan view. With this configuration, as shown in verification 4 of FIG. 9C, the load detection sensitivity of load sensor 10 can be further enhanced.

As illustrated in FIG. 2B, uneven shape 11a includes an end, the end being a substantially flat face 111a. In this case, the surface density of flat face 111a is preferably set to about less than or equal to 80%. With this configuration, as shown in verification 5 of FIGS. 10A and 10B, the load detection sensitivity of load sensor 10 can be enhanced.

As illustrated in FIG. 11A, the proportion of height H0 of uneven shape 11a to thickness T0 of conductive elastic member 20 (base member 11, conductive elastic body 12) excluding the thickness portion of uneven shape 11a is preferably about more than or equal to 10%. With this configuration, as shown in verification 6 of FIG. 11B, the load detection sensitivity of load sensor 10 can be enhanced.

As illustrated in FIG. 1, conductive member 13a is formed of a linear member. With this configuration, conductive member 13a can be easily overlapped with conductive elastic member 20 (base member 11, conductive elastic body 12).

As illustrated in FIG. 1, conductive clastic member 20 includes base member 11 having elasticity, conductive elastic body 12 having conductivity and elasticity, conductive elastic body 12 being formed on base member 11, wherein uneven shape 11a is formed on a surface of base member 11, the surface being opposite to a surface on which conductive elastic body 12 is formed. In this configuration, uneven shape 11a formed in base member 11 causes base member 11 to easily deform when a load is applied. As a result, the detection sensitivity of load sensor 10 can be enhanced.

As illustrated in FIG. 1, a plurality of conductive elastic bodies 12 are arranged side by side in one direction, and conductive member 13a is disposed across the plurality of conductive clastic bodies 12. With this configuration, a plurality of intersection positions of conductive elastic bodies 12 and conductive members 13a can be formed. Thus, a plurality of regions where a load can be detected can be arranged in load sensor 10.

As illustrated in FIG. 1, a plurality of conductive members 13a are each disposed across the plurality of conductive elastic bodies 12. With this configuration, a greater number of intersection positions of conductive elastic bodies 12 and conductive members 13a can be formed. Thus, a greater number of regions where a load can be detected can be arranged in load sensor 10.

As illustrated in FIG. 1, dielectric material 13b covers a surface of conductive member 13a. With this configuration, by overlapping conductive member 13a on conductive elastic body 12, dielectric material 13b can be interposed between conductive member 13a and conductive clastic body 12.

### Modification Example 1

The configuration of load sensor 10 can be variously changed in addition to the configuration described in the above-described exemplary embodiment.

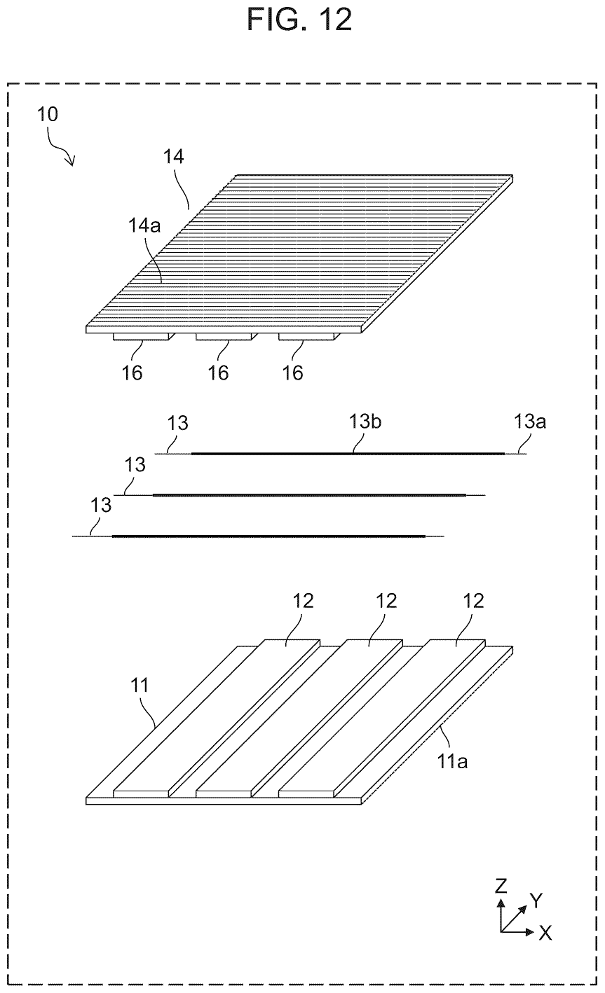

For example, in the above-described exemplary embodiment, conductive elastic body 12 is disposed only on the surface of base member 11 on the positive side of the Z axis, but as illustrated in FIG. 12, conductive elastic body 16 may be disposed also on the surface of base member 14 on the negative side of the Z axis. FIG. 12 is an exploded perspective view schematically illustrating a configuration of load sensor 10 of Modification Example 1. In this case, conductive elastic body 16 disposed on base member 14 is configured similarly to conductive clastic body 12 disposed on base member 11, and is disposed so as to overlap conductive elastic body 12 with conductor line 13 interposed therebetween in plan view. The wiring drawn out from conductive clastic body 16 disposed on base member 14 is connected to wiring W2 drawn out from conductive clastic body 12 facing in the Z-axis direction. When conductive elastic bodies 12, 16 are provided above and below conductor line 13 like this, the change in electrostatic capacitance in the element part (load detection region) is almost doubled corresponding to the upper and lower conductive elastic bodies. Thus, the detection sensitivity for the load applied to the element part can be further enhanced.

In this case as well, uneven shape 14a similar to uneven shape 11a is preferably formed on the surface of base member 14 opposite to the surface facing conductive member 13a. With this configuration, conductive elastic body 16 is more easily deformed when a load is applied, and the detection sensitivity of load sensor 10 can be further enhanced. In this configuration, conductive elastic body 16 and base member 14 also correspond to the conductive elastic member.

### Modification Example 2

In the above-described exemplary embodiment, uneven shape 11a is formed in base member 11, but an uneven shape may be formed in conductive elastic body 12.

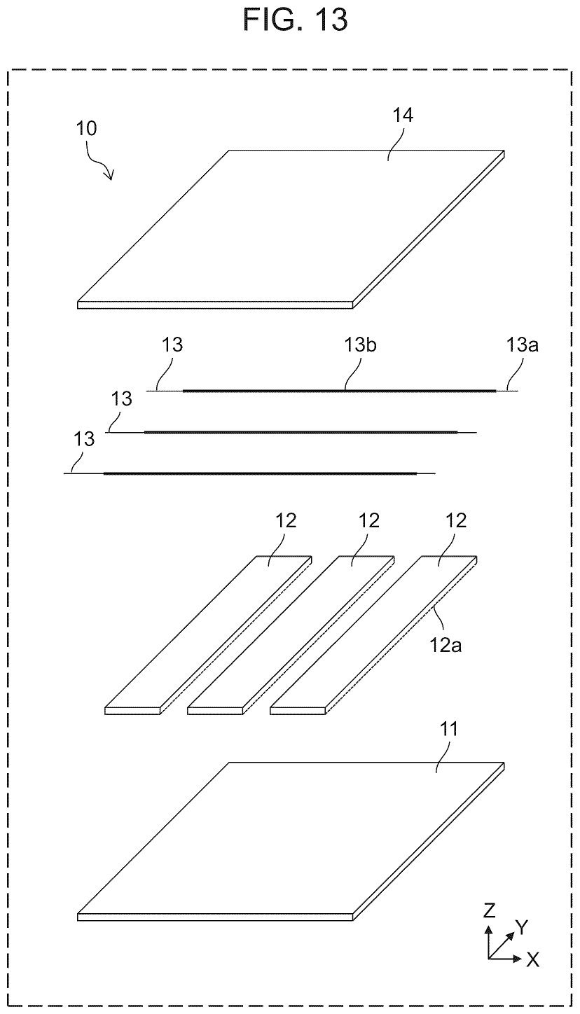

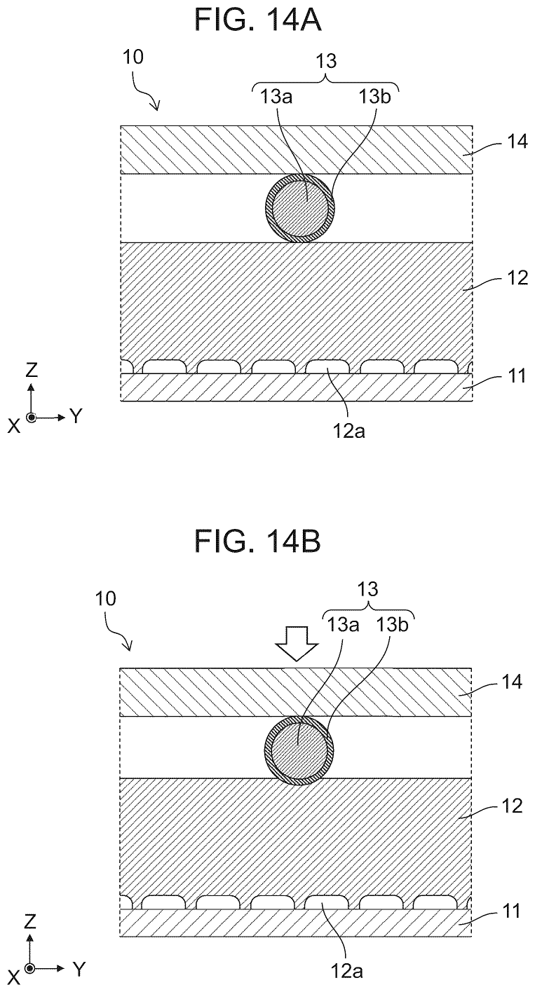

FIG. 13 is an exploded perspective view illustrating a configuration of load sensor 10 according to load sensor 10 of Modification Example 2. Each of FIGS. 14A and 14B is a diagram schematically illustrating a section of load sensor 10 of Modification Example 2 of the present embodiment when load sensor 10 is cut along a plane parallel to the Y-Z plane at a central position of conductive elastic body 12 in the X-axis direction. FIG. 14A illustrates a case where no load is applied, and FIG. 14B illustrates a case where a load is applied.

In load sensor 10 of Modification Example 2, uneven shape 12a (see FIGS. 14A and 14B) is formed on the surface of conductive elastic body 12 facing base member 11. Uneven shape 12a is formed in conductive elastic body 12 by a method similar to the method described with reference to FIG. 2C. In Modification Example 2, conductive elastic body 12 corresponds to conductive elastic member 20.

Conductive clastic body 12 is installed on base member 11 by using, for example, an adhesive. Alternatively, conductive elastic body 12 may be installed on base member 11 by using a thread or the like.

In the configuration of Modification Example 2, since uneven shape 12a is formed in conductive elastic body 12, conductive elastic body 12 itself is easily deformed elastically when a load is applied. Thus, as in the above-described exemplary embodiment, the load detection sensitivity of load sensor 10 can be enhanced.

In load sensor 10 of Modification Example 2 as well, uneven shape 12a may include a plurality of protrusions parallel to each other, or uneven shape 12a may include a plurality of protrusions arranged in a matrix. In addition, as in the case where uneven shape 12a is formed by pressing conductive elastic body 12 against cloth, uneven shape 12a may be formed by randomly disposing a plurality of protrusions.

### Modification Example 3

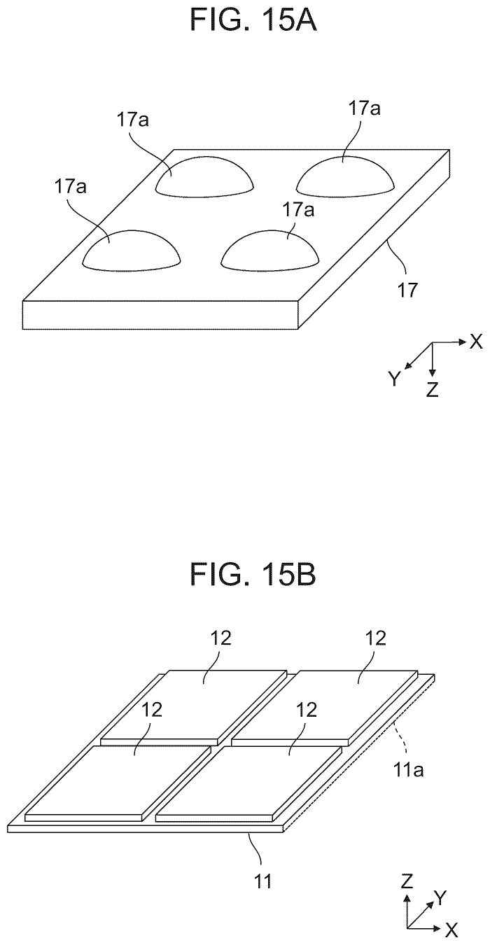

In the above-described exemplary embodiment, the element part (load detection region) is configured by conductive elastic body 12 and conductor line 13 intersecting each other, but the configuration of the element part is not limited to this configuration. FIG. 15A is a perspective view illustrating a configuration of base member 11 on which conductive member 17 and conductive elastic body 12 are disposed according to load sensor 10 of Modified Example 3. FIG. 15B is a perspective view illustrating a configuration of base member 11 on which conductive member 17 and conductive elastic body 12 are disposed according to load sensor 10 of Modification Example 3. For example, load sensor 10 may be configured by overlapping conductive member 17 having protrusion 17a with hemispherical shape as illustrated in FIG. 15A on conductive elastic body 12 disposed on base member 11 as illustrated in FIG. 15B. In this case, the dielectric material is formed on conductive member 17 so as to cover protrusion 17a, for example. Alternatively, the dielectric material may be uniformly formed on the surface of conductive member 17 on the negative side of the Z axis.

Conductive member 17 in FIG. 15A is turned upside down in the Z-axis direction and disposed on conductive elastic body 12. As a result, four protrusions 17a are disposed to face four conductive elastic bodies 12. The surface of protrusion 17a is covered with a dielectric material as described above. Thus, when conductive member 17 is overlapped with conductive elastic body 12 in this manner, the dielectric material is interposed between conductive member 17 and conductive elastic body 12.

In this configuration as well, uneven shape 11a is formed under base member 11. Uneven shape 11a may be configured by a plurality of ridges 111 parallel to each other, or may be configured by arranging a plurality of protrusions 114 in a matrix. Alternatively, a plurality of ridges 111 may be randomly arranged to form uneven shape 11a by a method of pressing conductive elastic body 12 against cloth to form uneven shape 11a as described above. In this configuration, base member 11 and conductive elastic body 12 correspond to the conductive elastic member.

The configuration of Modification Example 3 also can increase the load detection sensitivity.

### Other Modification Examples

In the above-described exemplary embodiment, conductor line 13 is made of a coated copper wire, but the conductor wire is not limited to this configuration. The conductor wire may be formed of a linear conductive member made of a material other than copper and a dielectric material covering the conductive member.

In the above-described exemplary embodiment, dielectric material 13b is formed on conductive member 13a so as to cover the outer periphery of conductive member 13a. Alternatively, dielectric material 13b may be formed on the upper surface of conductive elastic body 12. In this case, conductive member 13a sinks down so as to be wrapped by conductive elastic body 12 and dielectric material 13b according to the application of a load, and the contact area between conductive member 13a and conductive elastic body 12 changes. As a result, similarly to the above-described exemplary embodiment, a load applied to the element part (load detection region) can be detected.

FIGS. 4B and 14B illustrate an example in which a load is applied in the negative direction of the Z axis from the top of base member 14, but the load may be applied in the positive direction of the Z axis from the bottom of base member 11. In this case, in the configuration of FIG. 4B, for example, a protective substrate having a constant thickness is disposed on the surface of base member 11 on the negative side of the Z-axis. Load sensor 10 having this configuration is turned upside down in the Z-axis direction and installed on the installation surface.

In addition, various modifications can be appropriately made to the exemplary embodiments of the present disclosure within the scope of the technical idea disclosed in the claims.

### APPENDIX

The above description of the exemplary embodiment discloses technologies shown below.

### Technology 1

A load sensor including:
a conductive elastic member;
a conductive member disposed on the conductive elastic member; and
a dielectric material interposed between the conductive elastic member and the conductive member,
wherein the conductive elastic member including a surface having an uneven shape, the surface being opposite to a surface on which the conductive member is disposed. According to this technology, when a load is applied, the conductive elastic member is likely to be softly deformed so as to wrap the conductor line. Thus, the electrostatic capacitance between the conductive member and conductive elastic member is likely to change when a load is applied, and the load detection sensitivity can be enhanced.

### Technology 2

The load sensor according to Technology 1, wherein
the uneven shape includes a plurality of ridges parallel to each other.

According to this technology, as shown in verification 1 described above, the load detection sensitivity of the load sensor can be enhanced.

### Technology 3

The load sensor according to Technology 1, wherein
the uneven shape includes a plurality of protrusions arranged in a matrix.

With this technology as well, as shown in verification 3 described above, the load detection sensitivity of the load sensor can be enhanced.

### Technology 4

The load sensor according to any one of Technologies 1 to 3, wherein
the conductive member is overlapped with the conductive elastic member at a position of a recess of the uneven shape in plan view.

According to this technology, as shown in verification 4 described above, the load detection sensitivity of the load sensor can be further enhanced.

### Technology 5

The load sensor according to any one of Technologies 1 to 4, wherein
the uneven shape includes an end, the end being a substantially flat face, and
the substantially flat face has a surface density of about less than or equal to 80%.

According to this technology, as shown in verification 5 described above, the load detection sensitivity of the load sensor can be enhanced.

### Technology 6

The load sensor according to any one of Technologies 1 to 5, wherein the uneven shape has a height having a proportion to a thickness of the conductive elastic member excluding a thickness portion of the uneven shape of about more than or equal to 10%.

According to this technology, as shown in verification 6 described above, the load detection sensitivity of the load sensor can be enhanced.

### Technology 7

The load sensor according to any one of Technologies 1 to 6, wherein
the conductive member is formed of a linear member.

According to this technology, the conductive member can be easily overlapped with the conductive elastic member.

### Technology 8

The load sensor according to any one of Technologies 1 to 7, wherein
the conductive elastic member includes:
a base member having elasticity;
a conductive elastic body having conductivity and elasticity, the conductive elastic body being formed on the base member,
wherein the uneven shape is formed on a surface of the base member, the surface being opposite to a surface on which the conductive elastic body is formed.

According to this technology, the uneven shape formed in the base member causes the base member to easily deform when a load is applied. As a result, the detection sensitivity of the load sensor can be enhanced.

### Technology 9

The load sensor according to any one of Technologies 1 to 8, wherein
the conductive elastic member is a conductive elastic body integrally formed of a material having conductivity and elasticity.

According to this technology, the uneven shape formed in the conductive elastic body causes the conductive elastic body to easily deform when a load is applied. As a result, the detection sensitivity of the load sensor can be enhanced.

### Technology 10

The load sensor according to Technology 8 or 9, wherein
a plurality of the conductive elastic bodies each being the conductive elastic body are arranged side by side in one direction, and
the conductive member is disposed across the plurality of conductive elastic bodies.

According to this technology, a plurality of intersection positions of the conductive elastic bodies and the conductive members can be formed. Thus, a plurality of regions where a load can be detected can be arranged in the load sensor.

### Technology 11

The load sensor according to Technology 10, wherein
a plurality of the conductive members are disposed across the plurality of conductive elastic bodies.

According to this technology, a greater number of intersection positions of the conductive elastic bodies and the conductive members each being the conductive elastic body can be formed. Thus, a greater number of regions where a load can be detected can be disposed in the load sensor.

### Technology 12

The load sensor according to any one of Technologies 1 to 11, wherein
the dielectric material covers a surface of the conductive member.

According to this technology, by overlapping the conductive member on the conductive elastic body, the dielectric material can be interposed between the conductive member and the conductive elastic body.

As described above, the load sensor of the present disclosure can improve load detection sensitivity with a simple configuration. As described above, the load sensor of the present disclosure can be used in various devices to improve the performance of the devices, and is industrially useful.

What is claimed is:

1. A load sensor comprising:
a conductive elastic member;
a conductive member disposed on the conductive elastic member; and
a dielectric material interposed between the conductive elastic member and the conductive member,
wherein the conductive elastic member including a surface having an uneven shape, the surface being opposite to a surface on which the conductive member is disposed.

2. The load sensor according to claim 1, wherein the uneven shape includes a plurality of ridges parallel to each other.

3. The load sensor according to claim 1, wherein the uneven shape includes a plurality of protrusions arranged in a matrix.

4. The load sensor according to claim 1, wherein the conductive member is overlapped with the conductive elastic member at a position of a recess of the uneven shape in plan view.

5. The load sensor according to claim 1, wherein
the uneven shape includes an end, the end being a substantially flat face, and
the substantially flat face has a surface density of about less than or equal to 80%.

6. The load sensor according to claim 1, wherein the uneven shape has a height having a proportion to a thickness of the conductive elastic member excluding a thickness portion of the uneven shape of about more than or equal to 10%.

7. The load sensor according to claim 1, wherein the conductive member is formed of a linear member.

8. The load sensor according to claim 1, wherein
the conductive elastic member includes:
a base member having elasticity; and
a conductive elastic body having conductivity and elasticity, the conductive elastic body being formed on the base member,
wherein the uneven shape is formed on a surface of the base member, the surface being opposite to a surface on which the conductive elastic body is formed.

9. The load sensor according to claim 1, wherein the conductive elastic member is a conductive elastic body integrally formed of a material having conductivity and elasticity.

10. The load sensor according to claim 8, wherein
a plurality of the conductive elastic bodies each being the conductive elastic body are arranged side by side in one direction, and
the conductive member is disposed across the plurality of conductive elastic bodies.

11. The load sensor according to claim 10, wherein a plurality of the conductive members each being the conducive member are disposed across the plurality of conductive elastic bodies.

12. The load sensor according to claim 9, wherein
a plurality of the conductive elastic bodies each being the conductive elastic body are arranged side by side in one direction, and
the conductive member is disposed across the plurality of conductive elastic bodies.

13. The load sensor according to claim 12, wherein a plurality of the conductive members each being the conducive member are disposed across the plurality of conductive elastic bodies.

14. The load sensor according to claim 1, wherein the dielectric material covers a surface of the conductive member.
